(19) United States
(12) Patent Application Publication
(10) Pub. No.: US 2026/0098753 A1
(43) Pub. Date: Apr. 9, 2026

(54) POWDER DISPENSING HOPPER

(71) Applicant: XIM LLC, Cottonwood Heights, UT (US)

(72) Inventor: Tayler Scharman, Riverton, UT (US)

(73) Assignee: XIM LLC, Cottonwood Heights, UT (US)

(21) Appl. No.: 19/115,066

(22) PCT Filed: Dec. 22, 2023
(86) PCT No.: PCT/US2023/085655

§ 371 Date: Mar. 25, 2025

Related U.S. Application Data
(60) Provisional application No. 63/435,040, filed on Dec. 23, 2022.

(51) Int. Cl. G01G 13/06; G01F 11/24

(52) U.S. Cl. CPC G01G 13/06; G01F 11/24

(57) ABSTRACT

A powder dispensing hopper can include a reservoir with a rotatable bottom and a wall, a dispenser hole for dispensing powder, and an access guide movably coupled to the bottom relative to an access slide. The access slide can have an access hole that selectively aligns with the dispenser hole to dispense powder. The hopper also includes a dosage wheel within the reservoir, which has at least one slot, and a motor to rotate the base. The hopper can further include a load cell and a microcontroller to determine the weight of the hopper and its contents, and to measure the amount of powder by weight. The access hole may contact a mixing chamber inlet that can rotate on an inlet guide. The hopper may further include a reservoir holder having a reservoir shelf and a reservoir shelf guide which aligns the reservoir when placed into the reservoir holder.

### CROSS REFERENCE

This application claims benefit from currently pending U.S. Provisional Application No. 63/435,040 titled “Powder Hopper for a Mixing System” and having a filing date of Dec. 23, 2022, and all of which is incorporated by reference herein.

### FIELD OF THE INVENTION

The present specification relates generally to devices for dispensing powders and more specifically for a powder dispensing hopper that measures the weight of the powders, mixes and evenly dispenses the powder.

### BACKGROUND OF THE INVENTION

Food processors are common on the market today and are designed to mix, cut, chop, blend or otherwise process foods and powders. Given the advent of health-conscious individuals, there are people that are prioritizing their eating and drinking habits. As such, people are buying accessories, such as mixing cups, to accompany this healthy lifestyle to help make their food and drinks easier for consumption. Individuals have developed regular fitness regimes that ensure they eat properly, exercise daily and get the proper nutrition for their bodies to recover. Recovery can be assisted by mixing protein and vitamin powders into their diet. These powders are often mixed with food or liquids and are usually consumed in the morning or close to the time of exercise.

Since these proteins and vitamins are mixed into liquid it is common that proteins and vitamins are stored separate from the liquid until the time of consumption. Various products have been developed to assist in mixing these powders in with the liquids. For instance, some powders are mixed in bottles that are what contain a whisking ball that when the bottle is shook the whisking ball moves vigorously within the bottle mixing the powder within the liquid. Other bottles have a main container housing that stores the liquids and a housing to store the powders and allows the user to release the powder into the liquid when ready for use and then uses an impeller to mix the powder into the liquid, which requires the user to constantly wash and add more liquid and powder into the housings. Further, adding ice into the container requires the user to mix the powder into the liquid first, and then add ice after the mixing is complete.

Usually, these types of system require some type of powder dispensing reservoir that holds the powder and then releases the powder into a separate container that mixes the water or mixes the powder and water int the same container. These powder reservoirs usually have blades that rotate the powder and push the powder through a hole. The challenges is that it releases all of the powder in the reservoir creating inconsistent flow, residue and difficulties in achieving precise measurements. In addition, current solutions do not stir the powder efficiently loosening the powder and breaking up the powdered clumps before being put into the liquid.

Therefore, there is a need for a powder dispensing hopper that premixes the powder open and closes the reservoir and can dispense a user specified amount of powder into a liquid.

### BRIEF SUMMARY OF THE INVENTION

Accordingly, the present invention can comprise a powder dispensing hopper comprising a reservoir with a bottom that can have a dispenser hole for dispensing powder and a wall that rotates with the bottom. The hopper can include an access guide coupled to the bottom, which is movably coupled to an access slide having an access hole that selectively aligns with the dispenser hole to allow powder to be dispensed. The hopper can have a dosage wheel within the reservoir, which has at least one slot, and a motor to rotate the base within the reservoir.

The powder dispensing hopper can further include a load cell and a microcontroller that determine the weight of the hopper and its contents. The microcontroller can measure the amount of powder by weight and rotate the reservoir and access guide relative to the access slide to close the dispenser hole when a desired amount of powder has been dispensed. The motor may be coupled to a main gear comprising a main gear shaft that is rotatably coupled to the dosage wheel and a stir wheel.

The stir wheel can comprise at least one blade having at least one stir tooth. The powder dispensing hopper can further comprise a fixator that remains stationary relative to the stir wheel and dosage wheel. The fixator can comprise a paddle that can be coupled to a flap that contacts the dosage wheel and scrapes the powder into the dosage wheel's at least one slot. The access slide may be guided relative to an access guide, both of which comprise a magnet. When the access slide is in its open position, the magnets are removably coupled together.

The powder dispensing hopper can further comprise a lid coupled to the reservoir. The access hole may contact a mixing chamber inlet that can rotate on an inlet guide. The reservoir can rotate at least 5 degrees-30 degrees before stopping. The powder dispensing hopper can have a reservoir holder having a reservoir shelf and a reservoir shelf guide which aligns the reservoir when placed into the reservoir holder. The reservoir holder may further comprise a reservoir guide which aligns with a reservoir guide rail and guides the reservoir as it rotates. The access slide may have an access slide tab that comes into contact with a bottom tab on the reservoir. The motor may have a motor gear which contacts a secondary gear which contacts the main gear, increasing the speed of the rotating components.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of a powder dispensing hopper in accordance to one, or more embodiments;

FIG. 2a is an exploded front view of the powder dispensing hopper in accordance to one, or more embodiments;

FIG. 2b is a cross section exploded view of FIG. 2a of the powder dispensing hopper in accordance to one, or more embodiments;

FIG. 3 is an exploded front isometric top view of the powder dispensing hopper in accordance to one, or more embodiments;

FIG. 4 is an exploded front isometric bottom left view of the powder dispensing hopper in accordance to one, or more embodiments;

FIG. 5 is an exploded front isometric bottom right view of the powder dispensing hopper in accordance to one, or more embodiments;

FIG. 6 is a bottom view omitting the motor components of the powder dispensing hopper in accordance to one, or more embodiments;

FIG. 7 is a side view of the powder dispensing hopper in accordance to one, or more embodiments;

FIG. 8a is a front view of the powder dispensing hopper in accordance to one, or more embodiments;

FIG. 8b is the cross-sectional view of FIG. 8a of the powder dispensing hopper in accordance to one, or more embodiments; and

FIG. 9 is the isometric view of the powder dispensing hopper showing a powder mixing device in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

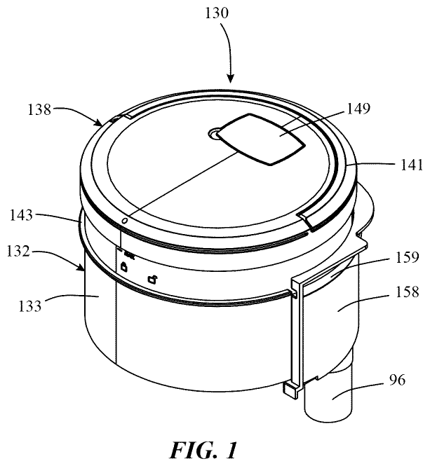

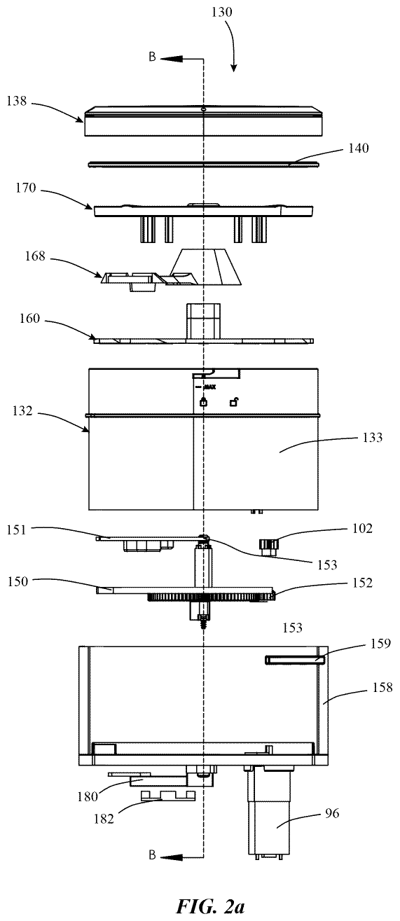

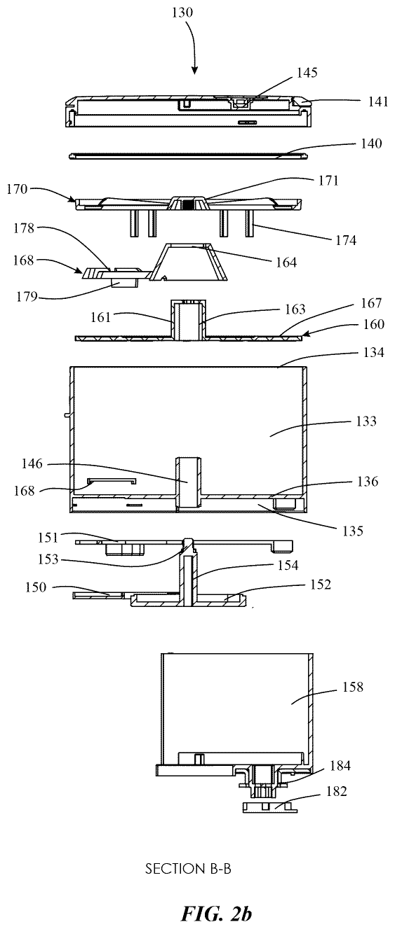

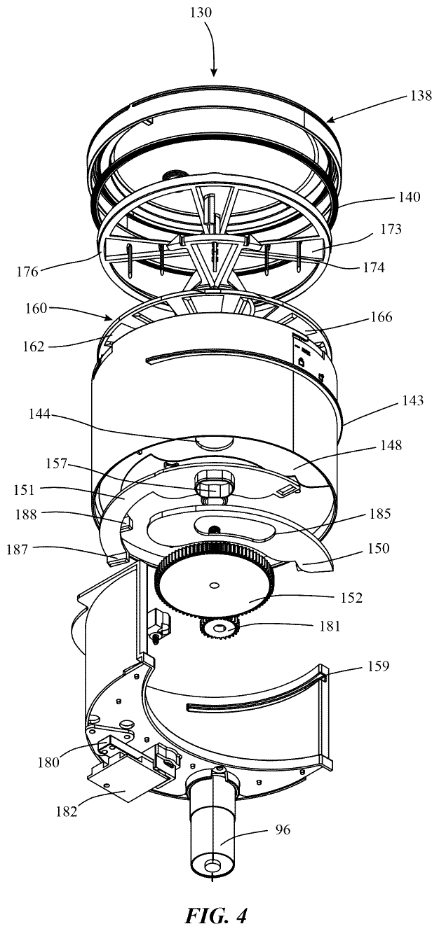

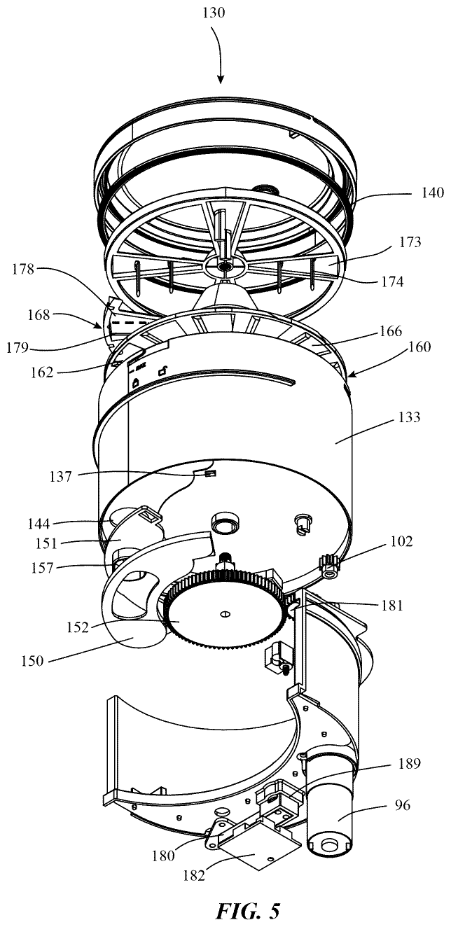

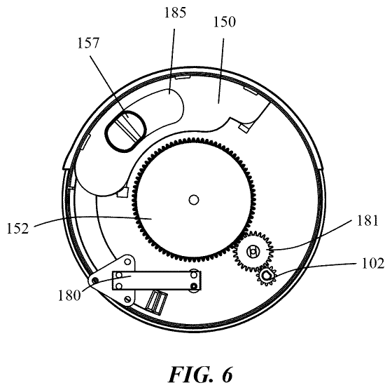

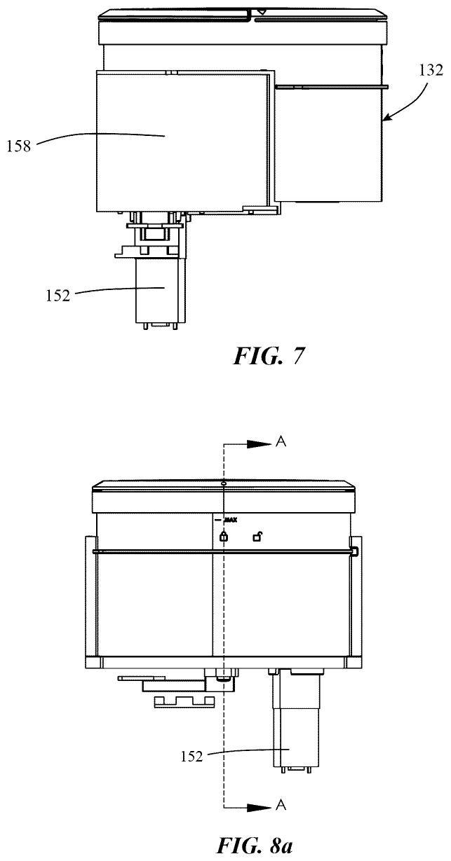

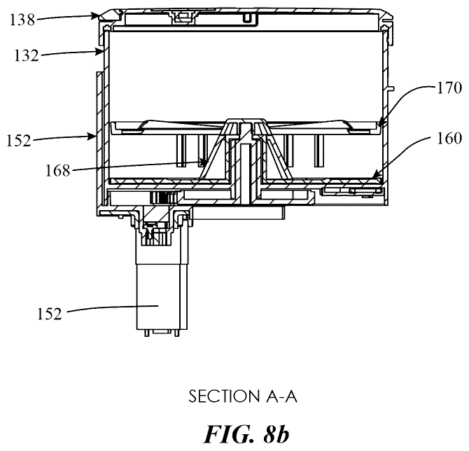

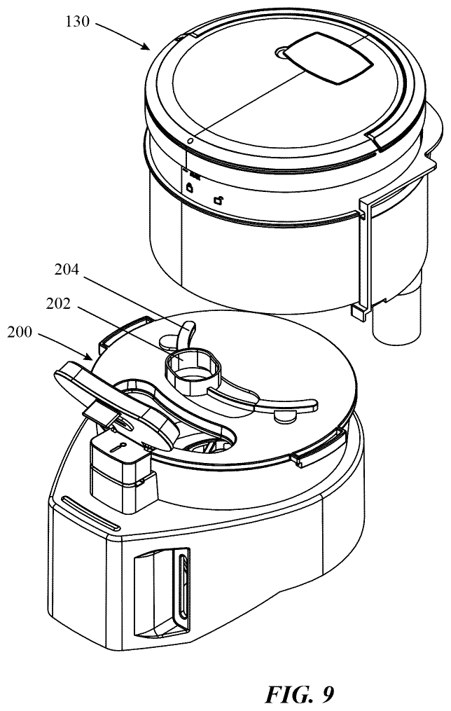

Referring to FIGS. 1-9, a powder dispensing hopper is shown generally at 130. A powder dispensing hopper 130 comprises a reservoir 132 having a bottom 136 that includes a dispenser hole 144 for dispensing powder from the reservoir. The reservoir 132 also includes a wall 133 that rotates with the bottom 136. The reservoir 132 can have an open end 134 and a bottom 136 which can be bottom with a wall 133 between the open end and bottom. The wall 133 can partially extend beyond the bottom forming a ledge 135 on the bottom of the reservoir 132. The wall can have a reservoir guide rail 143 on its outer diameter that partially extends beyond the outer diameter.

The open end 134 can be configured to partially of fully accept a lid 138 wherein the lid can have a gasket 140 around its outer diameter to keep the hopper from leaking powder out of the reservoir 132 and can create an airtight seal in the reservoir 132 to keep the powder within the hopper fresh. The lid 138 can be any suitable shape such as, for example, a circle, square, rectangle, or the like, but in the preferred embodiment it can be in the circular shape. The lid 128 can be removably attached to the reservoir 132 by such as, for example, twist with hook and grooves, snaps, fasteners, or the like. The lid 128 can have a lid hole 145 allowing the user access to the reservoir without removing the lid completely off the reservoir. The lid hole 145 can be covered with a lid hole cover 149 that is rotatably coupled to the lid and in certain embodiments at least one of the lid hole or lid hole cover can be omitted. The lid 138 can further comprise a handle 141 wherein the rotatable handle can be rotatably coupled to the lid.

In embodiments, the reservoir 132 can be any suitable shape such as, for example, circular, square, hexagon, or the like, but in the preferred embodiment the reservoir is circular. The bottom 136 can have a gear hole 146 and the dispenser hole 144 wherein the gear hole can be substantially centered on the bottom and the dispenser hole can be substantially near the outer diameter of the reservoir. The bottom 136 can have an access slide slot 148 which can partially cut into the bottom and can extend partially around the outer circumference of the bottom. The bottom 136 can have at least one access slide retainers 137 integral or coupled to it which can allow an access guide 150 to be attached to the bottom with the access slide 151 coupled between the access guide and the bottom allowing the reservoir 132 and the access guide to rotate keeping the access slide stationary which can selectively open and close the access hole 157 dispensing the powder or retaining the powder within the reservoir. In certain embodiments the bottom 136 can be flush with the with the wall 133.

In embodiments, the powder dispensing hopper 130 can further comprise a dosage wheel 160 within the reservoir 132, which has at least one slot 162 wherein in the preferred embodiment the slots can give an accurate dose of the powder. The slot 162 can give a consistent dosing of powder allowing at least between 1 gram to 10 gram and more preferrable 1.5 grams to 5 grams and still more preferably 2 grams. In the preferred embodiment the dosage wheel 160 can have 6 slots or 12 slots allowing for a more consistent dose or powder and the ability to weigh the dose as it falls into a mixing chamber 200 and in other embodiments the dosage can be such as, for example between 1-20 slots. For example for 30 grams and over the 12 slot 162 dosage wheel 160 can be used and 30 grams and below the 6 slot dosage wheel can be used giving a more consistent dose and a more accurate does. The dosage wheel 160 can be circular having at least one channel 166 and the last least one slot 162 space axial around the dosage wheel wherein in certain embodiments the channel can be omitted, and the dosage wheel can have a flat top with the slots spaced axially evenly around the dosage wheel.

A motor 96 can be provided to rotate the dosage wheel 160 within the reservoir 132. The motor 96 can be coupled to a main gear 152 that includes a main gear shaft 154 that can be rotatably coupled to the dosage wheel 160 and a stir wheel 170. The dosage wheel 160 can comprise a base shaft 163 with a hole 165 in its center wherein the base shaft can extend vertically from the dosage wheel platform. In certain embodiments, the dosage wheel 160 can have an outer ring and an inner ring which can be connected by the at least one channel 166 positioned axially around the inner and outer rings leaving the at least one slot between the channels. The channels 166 can be separated by at least one slot 162 positioned axially around the dosage wheel allowing the powder to be dropped into the mixing chamber 200. The dosage wheel 160 can have a depth between 1/16 of an inch and ½ of an inch. The volume of the slot 162 is between 0.75 and 3.5 milliliters.

In embodiments, the powder dispensing hopper 130 can further comprise an access guide 150 that can be coupled to the bottom 136 such that the access guide can be coupled to the bottom wherein the access guide and reservoir can rotate relative to an access slide 151. The access slide 151 can have an access hole 157 that can selectively align with the dispenser hole 144 to allow powder to be dispensed from the dispenser hole and access hole. In certain embodiments, the access slide 151 can move relative to the access guide 150 and/or reservoir 132. The access hole 157 can align and mate up with a mixing chamber inlet 202 wherein the mixing chamber inlet can capture the access hole and limit its movement by allowing the mixing chamber inlet to move on guides within an inlet guide 204 which can selectively open and close the hole allowing powder to be dispensed into the mixing chamber 200.

In embodiments, the powder dispensing hopper 130 can further comprise a main gear 152 wherein the main gear can comprise a main gear shaft 154 extending from at least one side of the main gear and in the preferred it extends towards the reservoir 132. The main gear shaft 154 can be circular and at least partially in the shape of such as for example, x-shape, t-shape, y-shape, or the like and in certain embodiment the main gear shaft can have threads 153 on its top portion. The main gear 152 can come into contact with or be coupled to a motor gear 102 which can come into contact with a hopper third gear which can be attached to a motor 96. The main gear 152, a motor gear 102 and a secondary gear 181 can be such as, for example, bevel gears, spur gears, miter gears, screw gears, or the like. The motor 96 can be such as, for example, AC motor, DC motor, brushless motor, stepper motor, or the like. The motor 96 can be controlled by the user at a set speed or at a variable speed. The motor 96 can be coupled to a motor support 184 wherein the motor support can be coupled to a reservoir holder 158.

The motor gear 102 can come into contact with the secondary gear 181 which can come into contact with the main gear which can create a gear ratio of such as, for example, 1:2, 1:3, 1:5, 1:10, 1:20, 1:30, 2:1, 3:1, 5:1, 10:1, 20:1, 30:1 or the like thus either increase or decreasing the speed of the dosage wheel 160 and the stir wheel 170. The main gear shaft 154 can be rotatably coupled to the dosage wheel 160 and the stir wheel 170 wherein the main gear shaft can rotate freely within the gear hole 146. The main gear shaft 154 can be coupled to a dosage wheel 160 and a stir wheel 170 wherein the dosage wheel can comprise a base hole 163 substantially centered on the blade base wherein the base hole can substantially match the main gear shaft 154 allowing the dosage wheel to rotate as the main gear 152 rotates by the motor 96.

The stir wheel 170 can comprise a cap 171 that can have a pocket or thread 172 that can substantially match the main gear shaft 154 allowing the stir wheel to rotate as the main gear rotates. The cap 171 and the blade hole 163 can be such as, for example, circular shape, x-shape, t-shape, y-shape, threaded or the like allowing the main gear shaft 154 to couple to the cap and the base hole 163. The stir wheel 170 includes at least one stir blade 173 having at least one stir tooth 174 on each at least one blade. The blade fixator 168 can remain stationary as the stir wheel 170 and dosage wheel 160 rotate within the hopper container.

In embodiments, the stir wheel 170 can be attached to the main gear shaft 154 wherein the hopper blade can have a corresponding hole that matches the shape and size of the main gear shaft 154. The main gear shaft 154 can be coupled to the stir wheel 170 by such as, for example, press fit, fasteners, adhesive, or the like wherein the hopper blade can fit within the reservoir 132 and can rotate within the hopper container's inner diameter. The stir wheel 170 can have an outer diameter and an inner diameter and can take on any suitable shape or size, but in the preferred embodiment it is substantially the same shape. The stir wheel 170 can have at least one at least one stir blade 173 and at least one stir tooth 174, extending from the stir blade on each stir blade, spaced evenly or unevenly around the stir wheel. The blade fixator 168, the dosage wheel 160 can be sandwiched between the bottom 136 and the stir wheel 170 and can operate together or as separate pieces when rotating.

In embodiments, the stir wheel 170 can further comprise at least one stir blade 173 extending outwardly from the cap 171 and ending at a first outer ring 176 and at least one tooth on each rotor blade. In the preferred embodiment the first outer ring 176 can have an integral upper ring and a lower ring wherein the lower ring can have a substantially smaller diameter than the upper ring. The stir blades 173 can be coupled to or apart of the lower ring and/or upper ring wherein the stir blades can be a flat and can be evenly spaced axially around the stir wheel 170. In other embodiments the upper ring and lower ring can be one solid ring and the stir blades 173 can be coupled to the outer ring. In embodiments, the at least one tooth 174 can extend from the bottom of the at least one stir blade 173 allowing the teeth to mix and scrap the excess powder around the dosage wheel 160 aiding in consistent powder and unclumped powder being dispensed into a mixing chamber 200.

The dosage wheel 160 can comprise a dosage wheel outer ring and a dosage wheel inner ring wherein the dosage wheel inner ring can have a plateau 167 a guide shaft 161 having a base hole 163 wherein the guide shaft can extend vertically from the plateau. The blade base outer ring and the blade base inner ring can be connected by at least one dosage wheel channel 166 positioned axially around the inner and out ring, wherein the blade base channels can be recessed or flush from the top edge of the blade base outer ring and can be separate pieces or integral to the blade base outer ring and blade base inner ring. The at least one dosage wheel channel 166 can be separated by at least one slot 162 positioned axially with the blade base channels wherein the holes allow powder to be dropped into the mixing chamber (not shown).

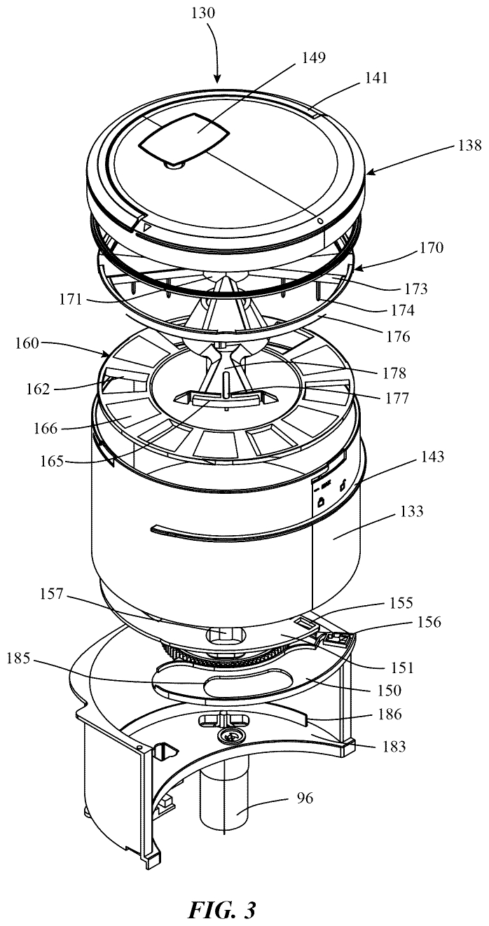

The blade fixator 168 can be any suitable shape having at least one paddle 178 with a flap 179 extending from the paddle towards the dosage wheel 160. The blade fixator 168 can level the powder that is in the slot 162 and keep additional powder from dropping into the mixing chamber 200 as it releases the powder. The dispenser hole 144 can be located under the least one paddle so that as the powder passes under the paddle it scraps the excess powder off of the slot 162 of the dosage wheel 160 and can dump the powder into to the dispenser hole at an accurate amount. In the preferred embodiment the blade fixator 168 can have the same shape or substantially the same shape as shown in FIG. 3. The blade fixator 168 can comprise a blade center hole 164 wherein the blade center hole can loosely fit around the main gear shaft 154 allowing the blade fixator to stay stationary while the stir wheel 170 and dosage wheel 160 can rotate freely within the reservoir 132. The blade fixator 168 can stay stationary by at least one blade capture point 169 wherein the capture point can partially extend from the inner diameter of the reservoir 132 capturing the end 165 of the blade fixator within the reservoir 132. The at least one blade capture 169 can be such as, for example, a ledge, hook, platform, or the like that can extends from the inner diameter of the reservoir 132 and can capture the end of the paddle 165 of the blade fixator 168.

The at least one paddle 178 can have a paddle slot 177 which can be coupled to a flap 179. The flap 179 can be made from such as, for example, silicone, plastic, rubber, or the like. The flap 179 can come into contact with the dosage wheel 160 wherein when the dosage wheel rotates the flap can push any excess powder off of the at least one dosage wheel channel 166 into the at least one slot 162 dispensing the powder evenly into the mixing chamber 200.

The reservoir holder 158 can have a reservoir shelf 183 and a reservoir shelf guide 186 which can align the reservoir 132 when placed into the reservoir holder. The reservoir holder 158 can further comprise a reservoir guide 159 which aligns with the reservoir guide rail 143 and guides the reservoir as it rotates. The reservoir guide 159 can extend partially around the reservoir holder 158. In the preferred embodiment the reservoir holder 158 can have a force sensor mount 189 which can have the force sensor 180 coupled to it.

In embodiments, the access slide slot 148 can be any suitable shape but in the preferred embodiment it can match the shape of the access guide 150. The access guide 150 can be attached to the bottom 136 by at least one access slide retainers 137 wherein the hook can be such as, for example, a snap hook, mounting boss, hook groove, fasteners, adhesive or the like. The access guide 150 can fully or partially contain the access slide 151 and the access guide can have an access guide slot 185 wherein the access hole can be partially inserted into and slide within the access guide slot. The access slide 151 can cover the dispenser hole 144 when not dispensing the powder and can remain in its closed or covering position when not attached, and/or stored away from the powder dispensing system (not shown).

The access slide 151 can comprise at least one cover magnet 155 and the access guide 150 can have at least one slide magnet 156 wherein the magnets can keep the access slide shut when not in use and when the dispensing the slider, having the access hole 157, can be aligned with the dispenser hole 144 allowing the powder to dispense the powder through both holes into the mixing chamber 200. The access slide 151 can further comprise a access slide tab 187 which can removably contact or permanently contact a bottom tab 188 which can extend from the reservoir bottom 136 which can allow the access slide to selectively rotate with the reservoir at least zero to forty-five degrees or in other embodiment keep the access slide stationary. In certain embodiments the at least one cover magnet 155 and the slider magnet 156 can be omitted.

In embodiments, the opening and closing of the access slide 151 on the bottom 136 protects the powder from steam (when mixing hot drinks) or mist and protects from possible splashing during mix cycles. The access slide 151 can let users completely detach and store the dispensing powder hopper 130 elsewhere without having any powder leaked or spilled from the bottom while removing it or storing it or can have multiple dispensing powder hopper with different powders for different applications. It also protects the powder by reducing the amount of air/light exposed to the powder.

In embodiments, the powder hopper assembly 130 can further comprise at least one force sensor 180 which can be such as, for example, load cell, strain gauges, single point, planar beam, s-type, or the like. The force sensors 180 can be coupled to the reservoir 132 or reservoir holder 158 or located near the reservoir on the force sensor mount 189 which can be located on the reservoir holder 158. The force sensors 180 can measure the difference in weight between the nominal weight of just of the reservoir 132, the reservoir holder 158 and any other component connected to the reservoir and the reservoir holder 158 and the delta between the nominal weight and each time powder is distributed into the mixing chamber 200 allowing the user to control in fine increments the amount of powder being dispensed. For example, if the reservoir 132 weighs 400 grams, the user wants to dispense 20 grams, when dispensing, the force sensors 180 can calculate the overall change in weight and when the hopper container reaches the set weight the motor 96 will stop rotating and the access slide 151 will close. The motor 96 can rotate the dosage wheel 160, the stir wheel 170 at a user or computer specified speed allowing fluid movement through the powder thus evenly dispensing the powder through the dispenser hole 144 and allowing different size granular powders to be easily dispensed.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A powder dispensing hopper comprising:
a reservoir having a bottom with a dispenser hole to dispense a powder from the reservoir and a wall that rotates with the bottom;
an access guide coupled to the bottom such that the access guide is movably coupled to the bottom relative to an access slide, the access slide having an access hole that selectively aligns with the dispenser hole to allow powder to be dispensed from the dispenser hole and access hole;
a dosage wheel within the reservoir, wherein the dosage wheel having at least one slot; and
a motor to rotate the dosage wheel within the reservoir.

2. The powder dispensing hopper according to claim 1, further comprising a force sensor and a microcontroller wherein the force sensor and the microcontroller determines the weight of the powder dispensing hopper and its contents.

3. The powder dispensing hopper according to claim 2, wherein the force sensor and the microcontroller measures the amount of powder by weight and rotates the reservoir and access guide relative to the access slide to close the dispenser hole when a desired amount of powder has been dispensed.

4. The powder dispensing hopper according to claim 1, wherein the motor is coupled to a main gear comprising a main gear shaft that is rotatably coupled to the rotatably base and a stir wheel and

5. The powder dispensing hopper according to claim 4, wherein the stir wheel comprises at least one blade having at least one stir tooth.

6. The powder dispensing hopper according to claim 1, wherein the powder dispensing hopper further comprises a fixator that remains stationary relative to the stir wheel and dosage wheel.

7. The powder dispensing hopper according to claim 1, wherein a fixator comprises a paddle wherein the paddle is couple to a flap that contacts the dosage wheel and scraps the powder into the dosage wheel's at least one slot.

8. The powder dispensing hopper according to claim 1, wherein the access slide is guided relative an access guide wherein the access slide and the access guide comprise a magnet wherein when the access slide is in its open position the magnets are removably coupled together.

9. The powder dispensing hopper according to claim 5, wherein the stir wheel comprises a first outer ring having an upper ring and a lower ring and an inner ring having a cap with a pocket wherein the at least one blade can extend between the outer ring and the inner ring.

10. The powder dispensing hopper according to claim 1, wherein the powder dispensing hopper further comprises a lid coupled to the reservoir.

11. The powder dispensing hopper according to claim 1, wherein the access hole contacts a mixing chamber inlet wherein the mixing chamber inlet can rotate on an inlet guide.

12. The powder dispensing hopper according to claim 1, wherein the reservoir rotates at least 5 degrees-30 degrees before stopping.

13. The powder dispensing hopper according to claim 1, wherein further comprises a reservoir holder having a reservoir shelf and a reservoir shelf guide which aligns the reservoir when placed into the reservoir holder.

14. The powder dispensing hopper according to claim 13, wherein reservoir holder further comprises a reservoir guide which aligns with a reservoir guide rail and guides the reservoir as it rotates.

15. The powder dispensing hopper according to claim 13, wherein the access slide has a access slide tab wherein the access slide tab comes into contact with a bottom tab.

16. The powder dispensing hopper according to claim 13, wherein the motor comprises a motor gear which contacts a secondary gear which contacts the main gear increasing the speed of the rotating components.

17. The powder dispensing hopper according to claim 3, wherein the force sensor is a load cell.
